(19) United States
(12) Patent Application Publication
(10) Pub. No.: US 2013/0334303 A1
(43) Pub. Date: Dec. 19, 2013

(54) METHOD AND SYSTEM FOR MANAGEMENT OF DATA IN ELECTRONIC FORMAT

(71) Applicants: Fabio Polvara, Galbiate (IT); Giorgio Polvara, Galbiate (IT); Mauro Bolis, Calolziocorte (IT)

(72) Inventors: Fabio Polvara, Galbiate (IT); Giorgio Polvara, Galbiate (IT); Mauro Bolis, Calolziocorte (IT)

(73) Assignee: TRIZERO S.R.L., Galbiate (Lecco) (IT)

(21) Appl. No.: 13/983,290

(22) PCT Filed: Feb. 2, 2011
(86) PCT No.: PCT/IT2011/000027

§ 371 Date: Sep. 3, 2013

(51) Int. Cl. G06F 17/30

(52) U.S. Cl. CPC G06F 17/30; G06F 17/3074
USPC 235/375

(57) ABSTRACT

A method for management of data in electronic format includes: providing a plurality of codes; selecting one of the codes; affixing the selected code (10) to a respective product or object (11); providing a first device (100) equipped with: a reading module (110) for reading and interpreting the code (10) and outputting a corresponding decoded information (DI); a data inserting module (120) for enabling a user to insert main data (MD); a transmitting module (130) for generating a main signal (MS) incorporating the decoded information (DI) and main data (MD). The method further includes a step of providing a storage apparatus (200) including: a receiving module (210) for receiving the main signal (MS); a memory (220) for storing the decoded information (DI) and main data (MD) associated with each other.

The present invention relates to a method and a system for management of data in electronic format.

It is known that in different sectors there is a requirement of associating information to objects or goods. This happens both in the private sphere and industrially, as well as in the commercial and logistic fields.

The solutions that have been hitherto utilised contemplate use of paper labels to which the necessary information is affixed; for convenience, the so-called Post-it® is often preferred; it is a sheet of paper material provided with an adhesive band enabling the sheet to be glued in a removable manner to the position preferred by the user.

It is clear that these solutions have many drawbacks:

first of all well apparent is the risk of losing the information (in particular, in the case of a Post-it® this risk is rather high);

the only way for reducing the risk of the data being lost consists in increasing the reliability of the mutual mechanical engagement between the label and the product/object; this however necessarily involves stiffening of the system and a substantial impossibility of modifying the information initially provided;

therefore, the only way enabling data to be modified/added consists in increasing the sizes of the paper medium utilised. This is not always possible and, at best, causes clear disadvantages in terms of convenience and bulkiness.

Presently, also known are the so-called QR codes, i.e.

graphic symbols capable of incorporating predetermined information. These codes can be interpreted by suitable readers, so as to give back the decoded data in an intelligible manner.

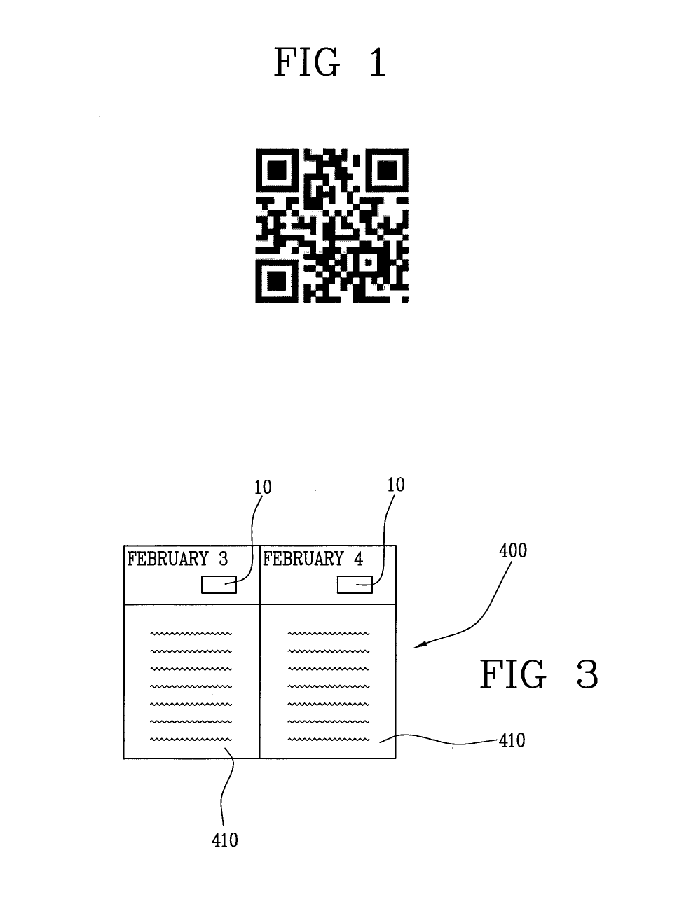

An example of QR code is shown in FIG. 1.

Typically the QR codes are used on magazines and publications in general, to support activities of the commercial and advertising type: at an advertising space dedicated, in a page, to a given product, a QR code is printed. This code has been suitably studied and created so that the information incorporated thereinto is a web address referring to a site describing the advertised product. In other words, the QR code in this case is a coded graphic representation of an Internet address.

At the moment the magazine's reader wishes to know the advertised product in depth, he/she does the necessary to activate a suitable device (typically a smart-phone) capable of detecting the QR code, interpreting it and being directly connected, through the Internet, to the site identified by the code itself.

The main drawback connected with this type of application resides in that the information identified by the QR code is decided a priori and is substantially unchangeable. In other words, the subject wishing to use the QR code in the above described manner, creates the code (or orders creation of same) in such a manner that the graphic thereof directly encodes the predetermined information, i.e. the web address to which the reader has to be connected.

The only way for modifying the data associated with the concerned code consists in a modification of the web site contents. Clearly, this operation involves a great operating complexity and requires that access to these contents be allowed, and also possession of the technical skill to enable intervention thereon.

It is therefore clear that this type of informative structure cannot be advantageously used for enabling the data associated with a given code to be personalised by everyone.

In the light of the above, it is an aim of the present invention to provide a method and a system for management of data in electronic format that will enable the information to be associated with an object or product in a simple, quick and personalised manner.

Another aim of the invention is to make available a method and a system enabling the information associated with the object or product, to be modified with ease and without essential limits to the number of the modifications.

Another aim of the invention is to provide a method and a system enabling data to be associated with an object or a product in a reliable manner and lasting in time.

It is a further aim of the invention to make available a method and a system enabling the information to be entered and retrieved even through different devices (i.e. without necessarily employing that same device), irrespective of the geographical position where the user is.

The foregoing and further aims are substantially achieved by a method and a system for management of data in electronic format as recited in the appended claims.

Further features and advantages will become more apparent from the detailed description of a preferred and not exclusive embodiment of the invention. This description is provided with reference to the accompanying drawings, given by way of non-limiting example, in which:

FIG. 1 shows an example of a QR code;

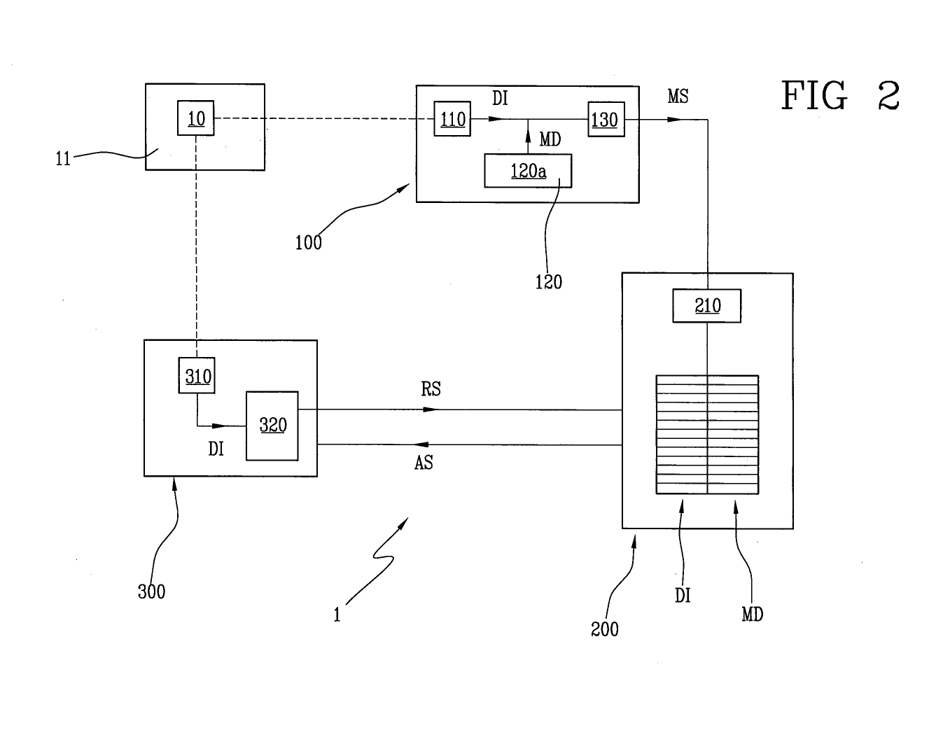

FIG. 2 is a block diagram representative of a system according to the present invention;

FIG. 3 shows an application example of the invention.

With reference to the accompanying drawings, a system according to the invention has been generally denoted at 1. System 1 is able to put into practice the method for management of data in electronic format according to the invention.

System 1 (FIG. 2) first of all comprises a plurality of codes 10, each affixed to a respective object or product 11.

Preferably, codes 10 are printed on adhesive paper material, consisting of adhesive labels for example. One or more labels, depending on requirements, can be applied to each of said products 11.

Preferably codes 10 are QR codes. The specifications concerning these codes are illustrated in the www.qrcode.com web site.

Practically, the concerned codes are able, in a graphic manner, to represent a unique encoding of a given alphanumeric string.

As already mentioned above, an example of a QR code is shown in FIG. 1.

Within the scope of the present invention, codes 10 are preferably generated starting from a series of alphanumeric strings produced randomly or according to a predetermined sequence.

Practically, codes 10 used in the present invention are directly representative of contents substantially having no meaning at the moment they are generated.

As better clarified in the following, the information associated with each code will be defined by the system's users.

In the preferred embodiment of the invention, therefore, a plurality of codes 10 are provided in the manner described above, which can then be affixed to the products or objects 11.

System 1 further comprises a first device 100 preferably of the electronic type. The first device 100 comprises a reading module 110 for reading and interpreting the aforesaid codes 10. Preferably, the reading module 110 can comprise a detecting device, such as a videocamera for example, and a processing unit suitably programmed for recognising codes 10 and outputting a corresponding decoded information DI from each of them. In other words, the reading module 110 when activated in correspondence with a code 10, is able to give back the corresponding decoded information DI, i.e. the alphanumeric string from which generation of code 10 in a graphic form has started.

Referring particularly to QR codes, the algorithm at the basis of the code generation and interpretation is well known by itself and therefore will not be described in detail.

The first device 100 further comprises a data inserting module 120, enabling a user to insert main data MD.

In an embodiment, the main data MD can be in graphic format. Preferably, the main data MD are in voice format.

Practically, the data inserting module 120 enables the user to insert data by talking; what the user is saying at a given moment can be received, stored and processed by the data inserting module 120.

By way of example, the data inserting module 120 may comprise a converter 120a for converting the voice signal inserted by the user into an electronic format, thus obtaining the aforesaid main data MD.

The first device 100 further comprises a transmitting module 130 configured for generating a main signal MS. The main signal MS incorporates the decoded information DI supplied by the reading module 110 and the main data MD inserted by the user.

The main signal MS is sent to a storage apparatus 200 to be described in the following.

Preferably, connection between the transmitting module 130 and storage apparatus 200 is of the remote type. Preferably, connection between the transmitting module 130 and storage apparatus 200 is of the wireless type.

The first device 100, in the preferred embodiment, can consist of, or comprise a smart-phone, i.e. a mobile phone of new generation. This device can advantageously use its videocamera integrated thereinto for detecting the code; a suitable application loaded in the device's processor carries out the code interpretation and enables the corresponding alphanumeric string to be obtained.

By means of the microphone (necessarily present in a telephone set) the user can enter the main data MD that can then be suitably treated by said processor.

Then the main signal MS is generated; the latter through the available connectivity, preferably through the Internet, is sent to apparatus 200, so that apparatus 200 can receive the alphanumeric string (i.e. the decoded information DI) and the main data MD. In this specific context, the transmitting module 130 can comprise all circuits/devices present within the smart-phone which help in connecting the first device 100 to the storage apparatus 200.

The storage apparatus 200 first of all comprises a receiving module 210 for receiving the main signal MS. Practically, the receiving module 210 allows a connection, preferably of the wireless and remote type, with the first device 100 and in particular with the transmitting module 130 being part of the latter.

By way of example, the transmitting module 130 and/or receiving module 210 can use the GSM technology, UMTS technology, etc.

The storage apparatus 200 further comprises a memory 220 for storing the decoded information DI and main data MD associated with each other.

In the preferred embodiment, the memory is structured, from the logical point of view, like a table in which each row is dedicated to a respective code 10; in particular, each row contains the alphanumeric string representative of a given code (i.e. the aforesaid decoded information DI), including the main data MD that were transmitted together with such a string.

In this manner, memory 220 of the storage apparatus 200 maintains the association between each code and the information that was associated therewith.

The storage apparatus 200 conveniently comprises a processing unit (not shown) suitably programmed for managing the receiving module 210 and memory 220 in the manner as above described. This processing unit further allows the answer operations to be performed which are addressed to a second device to be described in the following.

Advantageously, system 1 further comprises a second device 300 preferably of the electronic type. The second device 300 in turn comprises a reading module 310 for reading and interpreting the aforesaid codes 10.

Preferably, the reading module 310 can comprise a detecting device, such as a videocamera, and a processing unit, suitably programmed for recognising codes 10 and outputting a corresponding decoded information DI from each of them. In other words, the reading module 310, when activated in correspondence with a code 10, is able to give back the corresponding decoded information DI, i.e. the alphanumeric string from which generation of code 10 in graphic form has started.

Preferably, the reading module 310 of the second device 300 has a structure and operation similar to those of the reading module 110 of the first device 100.

The second device 300 further comprises a transmitting module 320 for sending a request signal RS incorporating the decoded information DI to the storage apparatus 200.

Preferably, connection between the second device 300, and in particular the transmitting module 320, and the storage apparatus 200 is of the remote type.

Preferably, connection between the second device 300, and in particular the transmitting module 320, and the storage apparatus 200 is of the wireless type.

The storage apparatus 200, on receipt of the request signal RS, selects within memory 220, the main data MD associated with the decoded information DI contained in the request signal RS.

Practically, apparatus 200 identifies in memory 220, the row in which the decoded information DI is and selects the main data MD that are in the same row.

Subsequently, apparatus 200 sends an answer signal AS incorporating the selected main data MD to the second device 300.

Preferably, transmission of the answer signal AS is carried out through a connection of the remote type.

Preferably, transmission of the answer signal AS is carried out through a connection of the wireless type.

Shortly, operation of system 1 can be illustrated as follows: through the first device 100 an association is created between code 10 and the main data MD entered by the user; the storage apparatus 200 keeps this information stored; through the second device 300 it is possible to benefit from the data previously associated with code 10.

By virtue of the fact that the concerned data (i.e. the decoded information DI and main data MD) are stored in the storage apparatus 200, that is distinct and physically separated from the first and second devices 100, 300, storage and retrieval of these data can be also carried out through devices different from each other (provided they have the minimum features for performing the herein described operations) and without important restrictions to the geographical position where the user is.

It should be noted that the first device 100 and second device 300 have been shown separately only for the sake of clarity and in order to make the treated subject simpler.

Practically, the first and second devices 100, 300 can be incorporated into the same apparatus (a smart-phone, for example), by means of which at first insertion of the data associated with a given code is carried out and subsequently the stored data are retrieved so as to be able to use them. In this context, it is possible to state that the first device 100 and second device 300 represent two distinct operating modes of the same apparatus.

Advantageously, this apparatus is provided to be equipped with a single reading module that can be used both in the first operating mode (data insertion) and in the second operating mode (retrieval of the previously inserted data).

Likewise, it is possible to use a single transceiver structure for connection with the storage apparatus 200, in the first and second operating modes.

It is also to be noted that the first and second devices 100, 300 can also be physically incorporated into two distinct apparatuses. For instance, each of the two devices 100, 300 can consist of a smart-phone. In this case, the information entered by a user, through the first device, can be retrieved by another user, through the second device.

An application example of the present invention relates to the diary field, and in particular to paper diaries.

A diary 400 (FIG. 3) comprises a plurality of pages 410; each pace is dedicated to one or more days, depending on the type of diary and day.

For instance, diary 400 can be a weekly diary; in this case it will be possible to identify three days in each page.

In a different example, diary 400 can be a daily diary and each page will be dedicated to one day alone (possibly, except the weekends, holidays, etc.).

By way of example, FIG. 3 diagrammatically shows an open daily diary in which two pages 410 are visible, each relating to a respective date.

According to the invention, at each date a code 10 can be printed or affixed. For each page or each date, a different code is provided, so that different information can be associated with different pages/dates.

No information of full meaning is associated a priori with code 10: code 10, as described above, is merely a graphic coding of an alphanumeric string generated in a random manner, or following a given logical order, but without the alphanumeric string being directly indicative of any useful data for the user.

It is exactly the user who has the possibility, through the first device 100, of associating the main data MD he/she prefers with each code 10 present in the diary.

Advantageously, the main data MD can consist of “voice notes” that the user dictates through his/her mobile phone (first device 100). Still through the first device 100 the user can afterwards retrieve (i.e. listen again to) the previously entered notes.

In greater detail, when the user has to enter his/her notes, he/she can do as follows:

through his/her smart-phone, he/she detects and interprets the code positioned at the date of interest;

through the smart-phone, he/she enters the notes (main data MD), in particular of the voice type, that he/she deems suitable;

still through his/her smart-phone, he/she sends to the storage apparatus 200, the alphanumeric string obtained from conversion of code 10 and the entered main data MD.

When, afterwards, for instance some days later, the user wishes to benefit from the previously entered notes, he/she can do as follows:

by means of said smart-phone he/she detects and decodes code 10 placed at the date of interest and sends the decoded information to the storage apparatus 200;

he/she will receive the data previously stored and associated with that date (i.e. that given code 10) from the storage apparatus 200.

A further application of the invention can be found in the publishing field. The object or product 11 in this case is a book.

In this book, preferably on the back cover, two codes are printed or affixed. One of these codes was already “utilised” and allows a voice message previously stored by the author to be listened to. In other words, using an apparatus having the functions of the aforesaid second device 300, it is possible to detect the code, send the respective decoded information to the storage apparatus 200 and receive the author's voice message in reply.

On the contrary the other code is still “free” and can be used by the user to, in turn, leave a message. In particular, an apparatus having the functions of the aforesaid first device 100 can be used.

The invention achieves important advantages.

First of all the invention enables the information to be associated with an object or product in a simple, quick and personalised manner.

In addition, through the invention the information associated with the object or product can be modified with ease and without important limits to the number of modifications.

Another advantage consists in that the invention enables data to be associated with an object or product in a reliable manner lasting in time.

A further advantage is found if it is considered that, locally, i.e. in the first or second electronic device 100, 300 no significant information is stored: the task of storing information fully relies on apparatus 200. In this manner even a loss, replacement, malfunction of devices 100, 300 does not compromise the integrity of the main data MD stored.

Another advantage of the invention is represented by the fact that the invention enables the information to be entered and retrieved even through different devices (i.e. without necessarily using the same device), irrespective of the geographical position where the user is.

1.-18. (canceled)

19. An electronic device comprising:
a reading module for reading and interpreting a code affixed to a respective product or object, and outputting a corresponding decoded information (DI);
a data inserting module for enabling a user to insert main data (MD);
a transmitting module for generating a main signal (MS) incorporating said decoded information (DI) and main data (MD), said main signal (MS) being sent to a storage apparatus configured for receiving said main signal (MS) and storing said decoded information (DI) and main data (MS) associated with each other.

20. A device as claimed in claim 19, wherein said codes are QR codes.

21. A device as claimed in claim 19, wherein said data inserting module comprises a converter for converting a voice signal inserted by said user in said main data (MD) into electronic format.

22. A device as claimed in claim 19, wherein each of said codes is a coded graphic representation of a random or progressive alphanumeric string.

23. A device as claimed in claim 19, wherein said codes are affixed to pages of a diary.

24. An electronic device comprising:
a reading module for reading and interpreting a code affixed to a product or object, thus obtaining a respective decoded information (DI);
a transmitting module for sending a request signal (RS) incorporating said decoded information (DI) to a storage apparatus;
said device being configured for receiving an answer signal (AS) incorporating main data (MD) from said storage apparatus; and
said main data (MD) being selected from said apparatus in a memory thereof containing a plurality of decoded information (D) and main data (MD) associated therewith; said main data (MD) being those associated with the decoded information (DI) incorporated into said request signal (RS).

25. A device as claimed in claim 24, wherein said codes are QR codes.

26. A device as claimed in claim 24, wherein said main data (MD) include a recorded voice signal in electronic format, said device being provided with a transducer configured to translate said main data (MD) and output said recorded voice signal in an audible format.

27. A device as claimed in claim 24, wherein each of said codes is a coded graphic representation of a random or progressive alphanumeric string.

28. A device as claimed in claim 24, wherein said codes are affixed to pages of a diary.
